(19) United States
(12) Patent Application Publication
(10) Pub. No.: US 2023/0335902 A1
(43) Pub. Date: Oct. 19, 2023

(54) MULTI-BAND ANTENNA AND COMMUNICATION DEVICE

(71) Applicant: HUAWEI TECHNOLOGIES CO., LTD., Shenzhen (CN)

(72) Inventors: Bing LUO, Shenzhen (CN); Wenfei QIN, Chengdu (CN); Jianping LI, Dongguan (CN)

(21) Appl. No.: 18/339,885

(22) Filed: Jun. 22, 2023

Related U.S. Application Data
(63) Continuation of application No. PCT/CN2020/139086, filed on Dec. 24, 2020.

(51) Int. Cl. H01Q 5/307; H01Q 13/10; H01Q 15/00

(52) U.S. Cl. CPC H01Q 5/307; H01Q 13/106; H01Q 15/0006

(57) ABSTRACT

Example multi-band antennas and communication devices are described. One example multi-band antenna includes a reflection plate and a feed structure. The reflection plate is provided with a slot, and the slot defines one strip conductor. One end of the strip conductor is connected to another part of the reflection plate. The feed structure includes a microstrip line used in a high-frequency antenna element in the multi-band antenna, where the microstrip line is located on one side of the reflection plate, and at least a part of a projection of the microstrip line on the reflection plate falls within a contour range of the strip conductor.

### CROSS-REFERENCE TO RELATED APPLICATIONS

This application is a continuation of International Application No. PCT/CN2020/139086, filed on Dec. 24, 2020, the disclosure of which is hereby incorporated by reference in its entirety.

### TECHNICAL FIELD

This application relates to the field of communication technologies, and in particular, to a multi-band antenna and a communication device.

### BACKGROUND

In a communication device such as a base station, a high-frequency antenna element and a low-frequency antenna element are usually configured at the same time. The high-frequency antenna element has a large signal transmission capacity, and the low-frequency antenna element has a strong signal anti-attenuation capability. To reduce a volume of the communication device, sometimes the high-frequency antenna element and the low-frequency antenna element need to be configured in a same antenna array to form a multi-band antenna.

In the multi-band antenna, a spacing between the high-frequency antenna element and the low-frequency antenna element is usually small. In this way, when an electromagnetic wave radiated by the low-frequency antenna element is coupled to the high-frequency antenna element, a common mode resonance is generated in the high-frequency antenna element, exciting a low-frequency induced current on a radiation part and a reflection ground of the high-frequency antenna element, where the induced current further excites a low-frequency electromagnetic wave. The low-frequency electromagnetic wave comprehensively acts with the electromagnetic wave directly radiated by the low-frequency antenna element. Consequently, pattern parameters such as gain stability and a polarization suppression ratio of the low-frequency antenna element deteriorate.

### SUMMARY

This application provides a multi-band antenna and a communication device, to improve directivity parameters such as a polarization suppression ratio and gain stability of a low-frequency antenna element in the multi-band antenna.

According to a first aspect, this application provides a multi-band antenna, the multi-band antenna includes at least one low-frequency antenna element and at least one high-frequency antenna element that is disposed on a same antenna array, and there may be a low-frequency antenna element and a high-frequency antenna element that are disposed close to each other. In addition, a maximum spacing between the low-frequency antenna element and the high-frequency antenna element that are disposed close to each other is less than 0.5 times a wavelength of the low-frequency antenna element, and the wavelength may be understood as a wavelength at which the low-frequency antenna element works in a vacuum. When the multi-band antenna is specifically disposed, the multi-band antenna may include a reflection plate and a feed structure. The reflection plate is provided with a slot, the slot defines one strip conductor, the strip conductor is a part of the reflection plate, and one end of the strip conductor is connected to another part of the reflection plate to implement grounding of the strip conductor. The feed structure includes a microstrip line used in a high-frequency antenna element in the multi-band antenna, where the microstrip line is located on one side of the reflection plate, and at least a part of a projection of the microstrip line on the reflection plate falls within a contour range of the strip conductor.

In the multi-band antenna provided in this application, the strip conductor forms a common mode suppression inductor structure. This can couple an electromagnetic wave radiated by the low-frequency antenna element to the high-frequency antenna element and can effectively suppress the common mode induced current generated on the high-frequency antenna element. In this way, directivity parameters such as a polarization suppression ratio and gain stability of the low-frequency antenna element are significantly improved. In addition, because the strip conductor is formed by slotting the reflection plate, to be specific, the strip conductor is used as a part of the reflection plate, a processing technology of the strip conductor is simple, and an additional structure and an assembly process do not need to be added. Therefore, the manufacturing costs of the multi-band antenna are low.

In addition, by using the technical solution in this application, impact of the common mode suppression inductor structure formed by the strip conductor on impedance continuity of the microstrip line can be avoided. This ensures impedances of all parts of the microstrip line are continuous. This can improve radiation efficiency and working stability of the high-frequency antenna element.

In a possible implementation of this application, a specific cabling shape of the strip conductor is not limited. For example, the strip conductor may be routed in a straight line shape, a snake line shape, or a fold line shape. Regardless of a shape of the strip conductor for routing, in a cabling direction of the strip conductor, a length of the strip conductor may be greater than one-twentieth of a wavelength of the low-frequency antenna element (where the wavelength may be understood as a wavelength at which the low-frequency antenna element works in a vacuum environment). In this way, the common mode induced current generated on the high-frequency antenna element can be effectively suppressed.

In a possible implementation of this application, in a direction perpendicular to cabling of the strip conductor, a width of the strip conductor may be 0.2 to 5 times a width of the microstrip line. For example, in a direction perpendicular to cabling of the strip conductor, a width of the strip conductor is 0.1 mm to 10 mm. In addition, a ratio of the length of the strip conductor in the cabling direction of the strip conductor to the width of the strip conductor in the direction perpendicular to the cabling direction of the strip conductor may be greater than 5:1. In this way, on the basis that a capacitance between the microstrip line and the strip conductor is basically unchanged, inductance of the common mode suppression inductor structure formed by the strip conductor is large. In this way, the common mode induced current can be effectively suppressed.

In a possible implementation of this application, when the feed structure is specifically disposed, the feed structure may further include a feed line. The feed line is separately connected to the microstrip line and the strip conductor, and is configured to feed power to a radiation part of the high-frequency antenna element. In a specific embodiment, the feed line usually includes a signal conductor and a ground conductor. The signal conductor may be connected to the microstrip line, and the ground conductor is connected to the strip conductor.

To implement connection between the feed line and the microstrip line, a through hole may be provided with the strip conductor. In this way, the feed line passes through the through hole and is connected to the microstrip line. Therefore, structure of the multi-band antenna can be simplified.

In addition, the feed structure further includes a feed connector, the feed connector and the microstrip line are disposed on a same side of the reflection plate, and the microstrip line is connected to the feed connector. In this way, the feed connector may be connected to a feed circuit, and a radio frequency signal may be transmitted to the radiation part by using the feed connector and the microstrip line for transmission.

In a possible implementation of this application, a slot may be a continuous slot disposed continuously, and a shape formed by the slot has a bottom and an open end. The multi-band antenna may further include a first jumper member and the open end, and the first jumper member is disposed between the bottom. A projection of the first jumper member on the reflection plate divides the slot into two parts. In addition, the strip conductor may be located between the first jumper member and the microstrip line, or the microstrip line may be located between the first jumper member and the strip conductor. Two ends of the first jumper member are respectively located on two sides of that are of the slot and that are away from the strip conductor, and the two ends of the first jumper member are separately connected to the reflection plate. In this way, the slot forms a short-circuit structure at a position of the first jumper member, which is equivalent to shortening a size of the slot in the cabling direction of the strip conductor. Therefore, leakage of a high-frequency signal from the slot to a back of the reflection plate can be effectively reduced, and impact of directivity parameters such as a front-to-back ratio, a polarization suppression ratio, and gain stability of the high-frequency antenna element can be reduced.

In this implementation, the slot may be a first U-shaped slot. In this case, the projection of the microstrip line on the reflection plate is inserted into an area defined by the first U-shaped slot. In this way, impedances of all parts of the microstrip line are continuous. This can improve radiation efficiency and working stability of the high-frequency antenna element.

In addition, to simplify a structure and a processing technology of the multi-band antenna, the multi-band antenna may be disposed based on a PCB structure. Specifically, the first jumper member, the reflection plate, and the microstrip line may be separately disposed on different conductor layers of a printed circuit board. In this implementation, the two ends of the first jumper member may be separately connected to the reflection plate through a via provided on the printed circuit board.

In another possible implementation of this application, a slot may alternatively be disposed a discontinuous slot. For example, the slot includes a first slot part and a second slot part that are separated from each other. In this case, the strip conductor includes a first conductor part and a second conductor part that are connected to each other. In this implementation, that the slot defines the strip conductor is specifically: the first slot part defines the first conductor part, and the second slot part defines the second conductor part.

The first slot part may be a closed ring-shaped slot, the second slot part may be a second U-shaped slot having an opening at one end, and the opening of the second U-shaped slot faces a side that is away from the ring-shaped slot. Since the first slot part and the second slot part are two ends that are not connected to each other, a part of the reflection plate located on circumferential side of the slot connects through a short circuit between the first slot part and the second slot part, which is equivalent to shortening a size of the slot in the cabling direction of the strip conductor. Therefore, leakage of a high-frequency signal from the slot to a back of the reflection plate can be effectively reduced, and impact of directivity parameters such as a front-to-back ratio, a polarization suppression ratio, and gain stability of the high-frequency antenna element can be reduced.

To implement a connection between the first conductor part and the second conductor part, the multi-band antenna may further include a second jumper member, and two ends of the second jumper member are respectively connected to the first conductor part and the second conductor part. Impact on the length of the cabling direction of the strip conductor can be reduced, and equivalent inductance of the common mode suppression inductor structure formed by the strip conductor does not change. In this way, the common mode induced current generated on the high-frequency antenna element can be effectively suppressed, and directivity parameters such as a polarization suppression ratio and gain stability of the low-frequency antenna element are significantly improved.

In this implementation, the multi-band antenna may also be disposed based on a PCB structure. Specifically, the reflection plate and the microstrip line may be separately disposed on different conductor layers of the printed circuit board, and the second jumper member and the microstrip line are located on a same conductor layer of the printed circuit board. In this implementation, two ends of the first jumper member may be separately connected to the reflection plate through a via provided on the printed circuit board. In this way, it can avoid increasing a quantity of conductor layer of a PCB. Therefore, costs of the multi-band antenna are effectively reduced.

In addition, there may be two second jumper members, and the two jumper members are respectively disposed on two sides of the microstrip line. In this way, a return current of the microstrip line is continuous, which effectively improves impedance continuity of all parts of the microstrip line, and further improves radiation efficiency and working stability of the high-frequency antenna element.

By adjusting a spacing between the second jumper member and the microstrip line, an impedance of the microstrip line can be controlled. In a possible implementation, a spacing between the second jumper member and the microstrip line may be 0.1 to 10 times thickness of a dielectric substrate of the PCB.

In a possible implementation of this application, the reflection plate may further have periodically arranged grid structures. In this case, the strip conductor may be disposed between the grid structures. Alternatively, the strip conductor is disposed in the grid structures. In this way, the multi-band antenna integrates functions such as directional reflection, spatial filtering, feed, and common mode suppression, and realizes comprehensive optimization of the multi-band antenna.

According to a second aspect, this application further provides a communication device. The communication device includes the multi-band antenna in the first aspect. The communication device may be, but is not limited to, a base station, a radar, or another device. In the communication device, a common mode suppression inductor structure formed by a strip conductor can effectively suppress a common mode induced current generated on a high-frequency antenna element in a multi-band antenna. In this way, directivity parameters such as a polarization suppression ratio and gain stability of a low-frequency antenna element are significantly improved. In addition, impedances of all parts of the microstrip line are continuous. This can improve radiation efficiency and working stability of the high-frequency antenna element. In addition, manufacture costs of the multi-band antenna are low. In this way, costs of an entire communication device can be effectively reduced.

### BRIEF DESCRIPTION OF DRAWINGS

FIG. 1 is a schematic diagram of a structure of an antenna feed system according to an embodiment of this application;

FIG. 2 is a schematic diagram of a structure of a base station antenna according to an embodiment of this application;

FIG. 3 is a schematic diagram of distribution of a multi-band antenna according to an embodiment of this application;

FIG. 4a is a pattern of a low-frequency antenna element in an antenna array including a low-frequency antenna element;

FIG. 4b is a pattern of a low-frequency antenna element in an antenna array including a low-frequency antenna element and a high-frequency antenna element;

FIG. 5 is a schematic diagram of a structure of a multi-band antenna according to an embodiment of this application;

FIG. 6 is a schematic diagram of a partial structure of a multi-band antenna according to an embodiment of this application;

FIG. 7 is a schematic diagram of an equivalent circuit formed at a strip conductor according to an embodiment of this application;

FIG. 8 is a top view of a reflection plate according to an embodiment of this application;

FIG. 9 is an exploded view of a multi-band antenna according to an embodiment of this application;

FIG. 10 is a sectional view of a multi-band antenna according to an embodiment of this application;

FIG. 11a is a schematic diagram of a structure of an antenna array including two low-frequency antenna elements according to this application;

FIG. 11b is a sectional view of FIG. 11a;

FIG. 11c is a pattern of a low-frequency antenna element in the antenna array shown in FIG. 11a;

FIG. 12a is a schematic diagram of a structure of an antenna array including two low-frequency antenna elements and eight high-frequency antenna elements according to this application;

FIG. 12b is a sectional view of the antenna array shown in FIG. 12a;

FIG. 12c is a pattern of a low-frequency antenna element in the antenna array shown in FIG. 12a;

FIG. 13a is a schematic diagram of a structure of an antenna array including two low-frequency antenna elements and eight high-frequency antenna elements according to this application;

FIG. 13b is a sectional view of the antenna array shown in FIG. 13a;

FIG. 13c is a pattern of a low-frequency antenna element in the antenna array shown in FIG. 13a;

FIG. 14 is a schematic diagram of a partial structure of a multi-band antenna according to another embodiment of this application;

FIG. 15 is a schematic diagram of a partial structure of a multi-band antenna according to another embodiment of this application;

FIG. 16 is a sectional view of the partial structure of the multi-band antenna provided in FIG. 15;

FIG. 17a is a schematic diagram of a structure of an antenna array including eight high-frequency antenna elements according to this application;

FIG. 17b is a sectional view of the antenna array shown in FIG. 17a;

FIG. 17c is a pattern of a high-frequency antenna element in the antenna array shown in FIG. 17a;

FIG. 18 is another pattern of a high-frequency antenna element in an antenna array including two low-frequency antenna elements and eight high-frequency antenna elements according to this application;

FIG. 19a is a schematic diagram of a structure of another antenna array including two low-frequency antenna elements and eight high-frequency antenna elements according to this application;

FIG. 19b is a pattern of a high-frequency antenna element in the antenna array shown in FIG. 19a;

FIG. 20 is an exploded view of a partial structure of a multi-band antenna according to another embodiment of this application;

FIG. 21 is a schematic diagram of a partial structure of a multi-band antenna according to another embodiment of this application;

FIG. 22 is a schematic diagram of a partial structure of a multi-band antenna according to another embodiment of this application;

FIG. 23 is a sectional view of a multi-band antenna according to another embodiment of this application;

FIG. 24 is an exploded view of a multi-band antenna according to another embodiment of this application; and

FIG. 25 is a schematic diagram of a structure of a multi-band antenna according to another embodiment of this application.

### REFERENCE NUMERALS

10: antenna; 1: low-frequency antenna element; 2: high-frequency antenna element; 101: radiation part; 1011: radiation surface reference dielectric substrate;
1012: first radiation arm; 1013: second radiation arm; 1014: coupling feed structure; 102: reflection plate; 1021: slot;
1021a: bottom; 1021b: open end; 1021c: first slot part; 1021d: second slot part; 1022: strip conductor;
1022a: first conductor part; 1022b: second conductor part; 10221: through hole; 1023: grid structure; 3: feed structure;
301: transmission component; 302: calibration network; 303: phase shifter; 304: combiner; 305: filter; 306: microstrip line;
307: feed line; 3071: inner conductor; 3072: outer conductor; 308: feed connector; 309: dielectric substrate;
4: first jumper member; 5: second jumper member; 20: pole; 30: antenna adjustment bracket; 40: radome;
50: radio frequency processing unit; 60: signal processing unit; and 70: cable.

### DESCRIPTION OF EMBODIMENTS

To make the objectives, technical solutions, and advantages of this application clearer, the following further describes this application in detail with reference to the accompanying drawings: It should be noted that the term “coupling” in the following means “a direct connection or an indirect connection”.

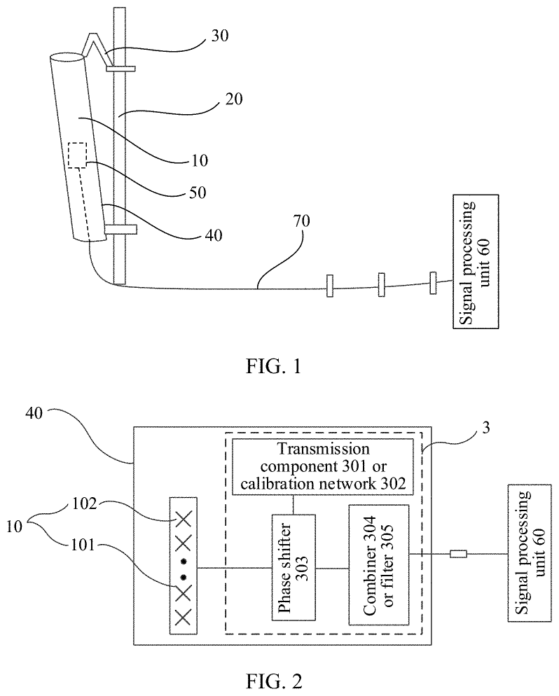

To help understanding of a multi-band antenna provided in embodiments of this application, the following describes an application scenario of the multi-band antenna: The multi-band antenna provided in embodiments of this application may be used in a communication device such as a base station. FIG. 1 is a schematic diagram of a structure of an antenna feed system of a base station according to an embodiment of this application. The antenna feed system of the base station may usually include structures such as an antenna 10, a pole 20, and an antenna adjustment bracket 30. The antenna 10 of the base station is usually disposed in a radome 40. The radome 40 has a good electromagnetic wave penetration characteristic in performance, and can withstand impact of a harsh external environment in terms of mechanical performance. This protects an antenna system from impact of an external environment. The radome 40 may be installed on the pole 20 or an iron tower by using the antenna adjustment bracket 30, to help receive or transmit signals of the antenna 10.

In addition, the base station may further include a radio frequency processing unit 50 and a signal processing unit 60. The radio frequency processing unit 50 may be configured to perform frequency selection, amplification, and down-conversion processing on a radio signal received by the antenna 10, convert the radio signal into an intermediate-frequency signal or a baseband signal, and send the intermediate-frequency signal or the baseband signal to the signal processing unit 60. Alternatively, the radio frequency processing unit 50 is configured to convert the signal processing unit 60 or an intermediate-frequency signal by performing up-conversion and amplification processing on the signal processing unit 60 or the intermediate-frequency signal into an electromagnetic wave by using the antenna 10 and send the electromagnetic wave. The signal processing unit 60 may be connected to a feed structure of the antenna 10 by using the radio frequency processing unit 50, and is configured to process the intermediate-frequency signal or the baseband signal sent by the radio frequency processing unit 50.

In a possible embodiment, the radio frequency processing unit 50 may be integrated with the antenna 10, and the signal processing unit 60 is located on a far end of the antenna 10. In some other embodiments, the radio frequency processing unit 50 and the signal processing unit 60 may be simultaneously located on the far end of the antenna 10. The radio frequency processing unit 50 and the signal processing unit 60 may be connected by using a cable 70.

More specifically, refer to FIG. 1 and FIG. 2 together. FIG. 2 is a schematic diagram of a structure of a base station antenna according to a possible embodiment of this application. As shown in FIG. 2, an antenna 10 of a base station may include a radiation part 101 and a reflection plate 102. The radiation part 101 may also be referred to as an antenna element, an element, or the like. The radiation part 101 is a unit forming a basic structure of an antenna array, and can effectively radiate or receive radio waves. In the antenna 10, frequencies of radiation parts 101 may be the same or different. The reflection plate 102 may also be referred to as a bottom plate, an antenna panel, a metal reflection surface, or the like. The reflection plate 102 may improve receiver sensitivity of an antenna signal, and reflects and concentrates antenna signals on a receiving point. In addition, the reflection plate 102 may implement directional radiation of the antenna signal, to improve radiation performance of the antenna 10. The radiation part 101 is usually disposed on one side surface of the reflection plate 102. This not only greatly enhances signal receiving or transmitting capability of the antenna 10, but also blocks and shields interference of other radio waves from a back surface of the reflection plate 102 (where the back surface of the reflection plate 102 in this application means a side that is of the reflection plate 102 and that is opposite to a side for disposing the radiation part 101) to signal receiving.

In the antenna 10 of the base station, the radiation parts 101 may receive or transmit radio frequency signals by using respective feed structures 3. The feed structure 3 usually includes a controlled impedance transmission line. The feed structure 3 may feed a radio signal to the radiation part 101 based on a specific amplitude and a specific phase, or send a received radio signal to a signal processing unit 60 of a base station based on a specific amplitude and a specific phase. In addition, the feed structure 3 may implement different radiation beam directions by using a transmission component 301, or may be connected to a calibration network 302 to obtain a calibration signal needed for a system. The feed structure 3 may include a phase shifter 303 to change a maximum direction of antenna signal radiation. The feed structure 3 may further include modules for expanding performance such as a combiner 304 (where the combiner 304 may be configured to combine signals of different frequencies into one channel of signals and transmit the signals by using the antenna 10; or when being used reversely, the combiner 304 may be configured to divide the signals received by the antenna 10 into a plurality of channels of signals based on different frequencies to transmit the plurality of channels of signals to the signal processing unit 50 for processing), or a filter 305 (configured to filter out an interference signal).

Currently, in the base station antenna, a low-frequency antenna element 1 and a high-frequency antenna element 2 are usually configured in a same antenna array at the same time, to form a multi-band antenna. In embodiments of this application, specific working frequencies of the low-frequency antenna element 1 and the high-frequency antenna element 2 are not limited, but the working frequency of the high-frequency antenna element 2 is higher than the working frequency of the low-frequency antenna element 1. For example, the working frequency of the high-frequency antenna element 2 may be 30% higher than the working frequency of the low-frequency antenna element 1.

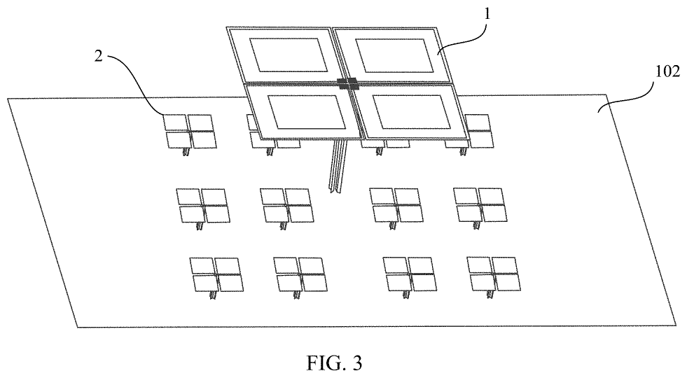

FIG. 3 shows a schematic diagram of distribution of an antenna. The antenna includes one low-frequency antenna element 1 distributed on a reflection plate 102 and a plurality of high-frequency antenna elements 2 distributed around the low-frequency antenna element 1, and the low-frequency antenna element 1 and the high-frequency antenna elements 2 share one antenna array (in other words, an area in which the reflection plate 102 is located). The low-frequency antenna element 1 and a high-frequency antenna element 2 are disposed close to each other. A maximum spacing between the low-frequency antenna element 1 and the high-frequency antenna element 2 is sometimes less than 0.5 times a wavelength of the low-frequency antenna 1. The wavelength may be understood as a wavelength at which the low-frequency antenna element 1 works in a vacuum environment, to form a common aperture antenna. Antenna elements of two or more frequency bands are arranged on a same antenna array by using a common aperture technology. In this way, a dimension of the multi-band antenna can be greatly reduced, and application advantages such as miniaturization, lightweight, and easy deployment can be obtained.

Still refer to FIG. 3. However, in the common aperture antenna, because a spacing the high-frequency antenna element 2 and the low-frequency antenna element 1 is small. When an electromagnetic wave radiated by the low-frequency antenna element 1 is coupled to the high-frequency antenna element 2, a common mode resonance is generated on the high-frequency antenna element 2. Therefore, a low-frequency common mode induced current is excited on a radiation part and a reflection ground of the high-frequency antenna element 2, and the common mode induced current further excites a low-frequency electromagnetic wave. The low-frequency electromagnetic wave comprehensively acts with the electromagnetic wave directly radiated by the low-frequency antenna element 1. Consequently, pattern parameters such as gain stability and a polarization suppression ratio of the low-frequency antenna element 1 deteriorate.

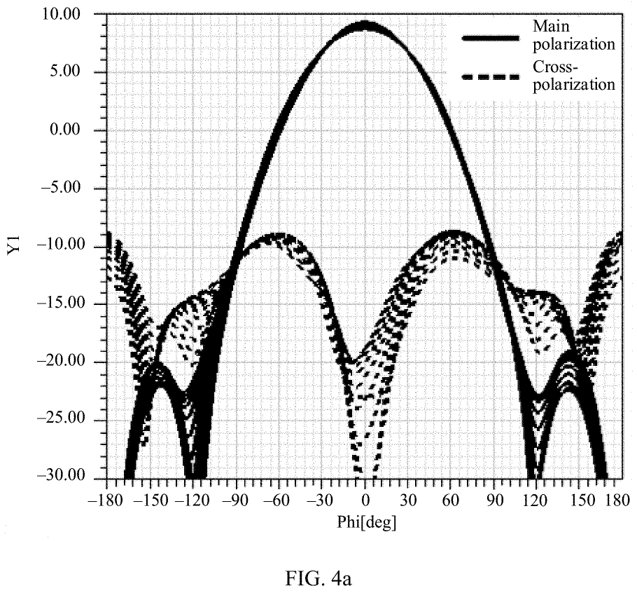

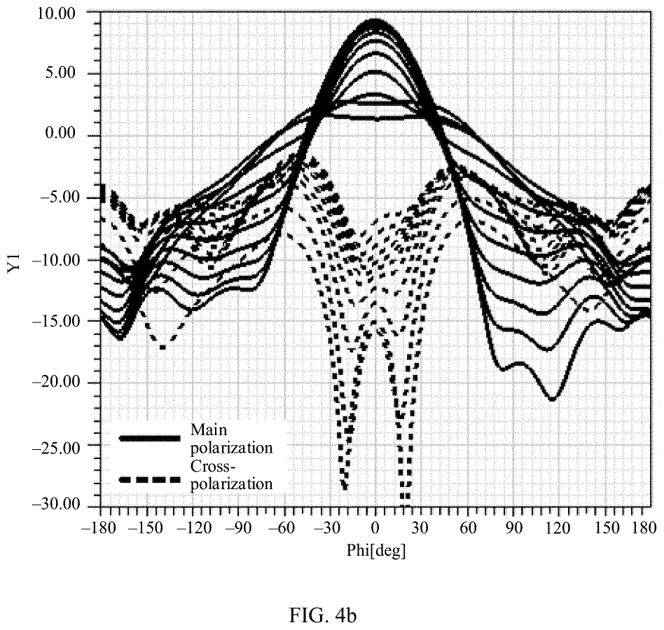

Specifically, refer to FIG. 4a and FIG. 4b together. FIG. 4a is a polarization pattern of a low-frequency antenna element 1 in an antenna array including the low-frequency antenna element 1, and FIG. 4b is a polarization pattern of the low-frequency antenna element 1 in the multi-band antenna in FIG. 3. FIG. 4a and FIG. 4b show main polarization pattern curves and cross-polarization pattern curves of some frequencies selected at equal intervals in a working frequency band of the low-frequency antenna element 1. Each solid line represents a main polarization pattern curve corresponding to one frequency in the working frequency band of the low-frequency antenna element 1, and each dashed line represents a cross-polarization pattern curve corresponding to one frequency in the working frequency band of the low-frequency antenna element 1, to reflect directivity parameters such as gain stability and a polarization suppression ratio of the low-frequency antenna element 1 in the entire working frequency band. In addition, in FIG. 4a and FIG. 4b, a vertical coordinate represents a normalized gain, and a unit thereof is dB (decibel). A horizontal coordinate represents an azimuth Phi, and a unit thereof is “°” (namely, degree). A solid line part represents a main polarization pattern, and a dashed line part represents a cross-polarization pattern. It may be understood that, in this embodiment of this application, a polarization form of the low-frequency antenna element 1 may be, but is not limited to, single-polarization, dual-polarization, circular polarization, or the like. Polarization directions of the low-frequency antenna element 1 shown in FIG. 4a and FIG. 4b are the same.

By comparing FIG. 4a and FIG. 4b, it can be learned that a downward depression s on a top part of a main lobe of the solid line part in FIG. 4b relative to a top part of a main lobe of the solid line part in FIG. 4a. This indicates that, after the high-frequency antenna element 2 is disposed in the array of the low-frequency antenna element 1, the gain stability of low-frequency antenna element 1 deteriorates, and a gain of some frequencies decreases by more than 6 dB. In addition, an average value of the dashed line part in FIG. 4b is greatly increased compared with an average value of the dashed line part in FIG. 4a. This indicates that, after the high-frequency antenna element 2 is disposed in the array of the low-frequency antenna element 1, the polarization suppression ratio of the low-frequency antenna element 1 deteriorates.

Based on this situation, embodiments of this application provide a multi-band antenna, to improve the directivity parameters such as the polarization suppression ratio and the gain stability of the low-frequency antenna element 1 in the multi-band antenna, and improve radiation efficiency and working stability of the high-frequency antenna element 2.

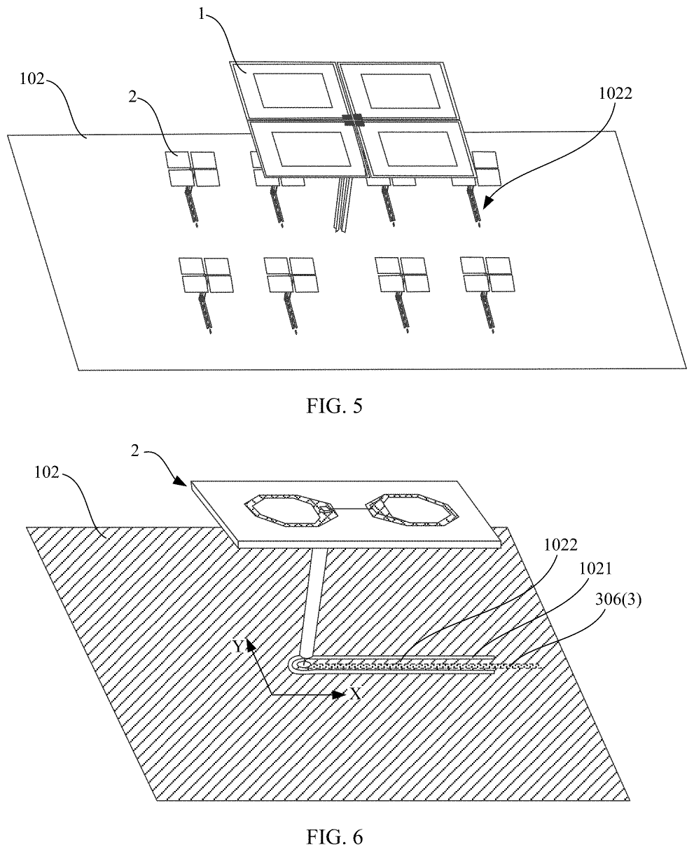

FIG. 5 is a schematic diagram of a structure of a multi-band antenna according to an embodiment of this application. The multi-band antenna includes a reflection plate 102, and a low-frequency antenna element 1 and a high-frequency antenna element 2 that are distributed on the reflection plate 102. A material of the reflection plate 102 may be, but is not limited to, metals such as gold, silver, copper, iron, or aluminum, or alloys such as stainless steel, aluminum alloy, or nickel alloy. In this embodiment of this application, there is at least one low-frequency antenna element 1 and at least one high-frequency antenna element 2. The low-frequency antenna element 1 is located on a peripheral side of the high-frequency antenna element 2, and the low-frequency antenna element 1 and the high-frequency antenna element 2 may be distributed on the reflection plate 102 in an array, but are not limited thereto.

Refer to FIG. 5 and FIG. 6 together. FIG. 6 is a schematic diagram of a partial structure of a multi-band antenna according to a possible embodiment of this application. In this application, a reflection plate 102 is provided with a slot 1021, and the slot 1021 defines a strip conductor 1022. During specific implementation, a direction of the slot 1021 may be in a semi-enclosed shape with an opening at one end. In this way, a semi-enclosed strip area is obtained from the reflection plate 102, and the strip conductor 1022 is located on the semi-enclosed strip area. In this application, a specific cabling shape of the strip conductor 1022 is not limited. For example, the strip conductor 1022 may be routed in a straight line shape, a snake line shape, or a fold line shape. Regardless of a shape in which the strip conductor 1022 is routed, in a cabling direction of the strip conductor 1022 (an X direction shown in FIG. 6), a length of the strip conductor 1022 may be greater than one-twentieth of a wavelength of a low-frequency antenna element 1. The wavelength may be understood as a wavelength at which the low-frequency antenna element 1 works in a vacuum environment. In addition, in a plane in which the reflection plate is located, a width of the strip conductor 1022 may be 0.1 mm to 10 mm in a direction perpendicular to cabling of the strip conductor 1022 (an Y direction shown in FIG. 6). In some embodiments, a ratio of the length of the strip conductor 1022 in the cabling direction of the strip conductor 1022 to the width of the strip conductor 1022 in the direction perpendicular to the cabling of the strip conductor 1022 may be greater than 5:1.

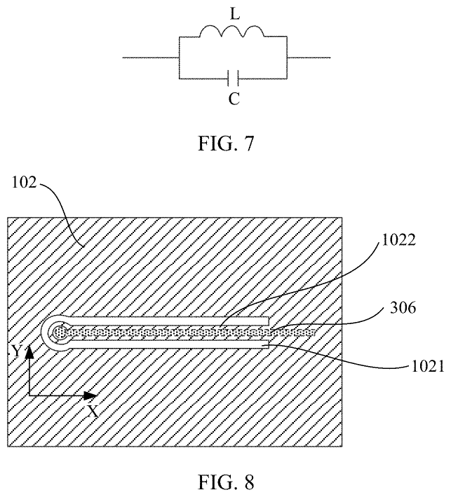

It may be understood that, in this application, one end of the strip conductor 1022 is still connected to another part of the reflection plate 102 (where a connection mode may be a direct connection or an indirect connection). In other words, the strip conductor 1022 is still a part of the reflection plate 102. In this way, grounding of the strip conductor 1022 is implemented. In this case, for a common mode induced current excited by the high-frequency antenna element 2, the strip conductor 1022 is equivalent to a common mode suppression inductor structure. In addition, an inductor-capacitor parallel resonant circuit (LC parallel resonant circuit) shown in FIG. 7 is formed in the area in which the strip conductor 1022 is located. In this way, the common mode induced current can be suppressed.

To effectively suppress the common mode induced current generated on the high-frequency antenna element 2, the strip conductor 1022 may be disposed corresponding to the high-frequency antenna element 2. Still refer to FIG. 6. During specific implementation, the multi-band antenna further includes a feed structure 3, and the feed structure 3 includes a microstrip line 306 used in the high-frequency antenna element 2. The microstrip line 306 is located on one side of the reflection plate 102, and at least a part of a projection of the microstrip line 306 on the reflection plate 102 falls within a contour range of the strip conductor 1022. In some embodiments of this application, the microstrip line 306 and the strip conductor 1022 may be disposed in parallel. In other words, a cabling direction of the microstrip line 306 and the cabling direction of the strip conductor 1022 may be the same. Further, a cabling shape of the microstrip line 306 and a cabling shape of the strip conductor 1022 may be the same or different, provided that spacings between the microstrip line 306 and the reflection plate 102 may be approximately the same in a thickness direction of the reflection plate 102. In this way, impact of the common mode suppression inductor structure formed by the strip conductor 1022 on impedance continuity of the microstrip line 306 can be avoided. This ensures impedance continuity of all parts of the microstrip line 306. In this way, radiation efficiency and working stability of the high-frequency antenna element 2 are improved.

In addition, in the direction perpendicular to the cabling of the strip conductor 1022, the width of the strip conductor 1022 may be 0.2 to 5 times a width of the microstrip line 306. In this way, on the basis that a capacitance between the microstrip line 306 and the strip conductor 1022 is basically unchanged, inductance of the common mode suppression inductor structure formed by the strip conductor 1022 is large. In this way, the common mode induced current can be effectively suppressed.

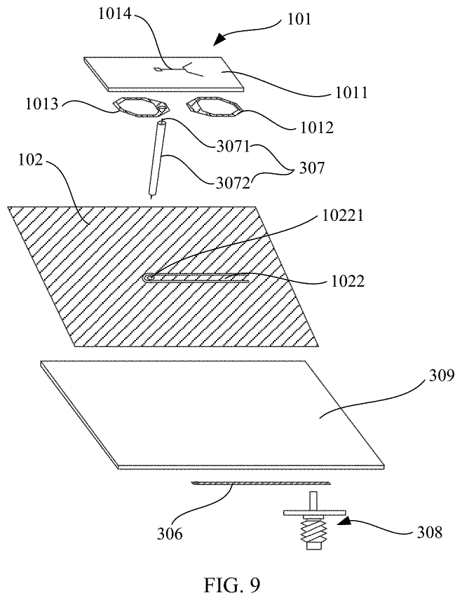

In a possible embodiment of this application, the slot 1021 may be disposed around the microstrip line 306. During specific implementation, refer to FIG. 8. First, a microstrip line 306 is disposed on a reflection plate 102, and then a slot 1021 is disposed around the microstrip line 306 on the reflection plate 102 to obtain a strip conductor 1022. In this way, a processing technology of a multi-band antenna can be effectively simplified. In this embodiment, a cabling direction of the microstrip line 306 and a cabling direction of the strip conductor 1022 may be the same, and the slot 1021 may be, but is not limited to, a U-shaped slot. It may be seen from FIG. 8 that, in a direction perpendicular to cabling of the strip conductor 1022, a width of a projection of the microstrip line 306 on the reflection plate 102 may be less than or equal to a width of the strip conductor 1022. In the cabling direction of the strip conductor 1022, a length of the projection of the microstrip line 306 on the reflection plate 102 is greater than a length of the strip conductor 1022. In this way, a part of the projection of the microstrip line 306 on the reflection plate 102 is located on an area defined by the U-shaped slot, and the other part extends from an opening of the U-shaped slot to the defined area. This may be understood as that the projection of the microstrip line 306 on the reflection plate 102 is inserted in the area defined by the U-shaped slot. In this way, impedances of all parts of the microstrip line 306 are continuous.

FIG. 9 shows a manner of disposing a high-frequency antenna element 2 according to a possible embodiment of this application. In this embodiment, a feed structure 3 further includes a feed line 307. The feed line 307 is separately connected to a microstrip line 306 and a strip conductor 1022, and the feed line 307 may be configured to feed power to a radiation part 101 of the high-frequency antenna element 2.

During specific embodiment, the radiation part 101 of the high-frequency antenna element 2 is disposed on a side that is of the reflection plate 102 and that is away from the microstrip line 306. The radiation part 101 of the high-frequency antenna element 2 may include a radiation surface reference dielectric substrate 1011 and is disposed on a first radiation arm 1012, a second radiation arm 1013, and a coupling feed structure 1014 of the radiation surface reference dielectric substrate 1011. The first radiation arm 1012 and the second radiation arm 1013 are disposed on a first surface of the radiation surface reference dielectric substrate 1011, and the coupling feed structure 1014 is disposed on a second surface of the radiation surface reference dielectric substrate 1011. In addition, in the embodiment shown in FIG. 9, the feed line 307 is a coaxial feed line. In some other embodiments of this application, the feed line 307 may alternatively be, but is not limited to, a microstrip line structure, a strip line, a coplanar waveguide (CPW) transmission line, or the like. It may be understood that, regardless of a form of the feed line 307, each form of the feed line 307 is provided with a signal conductor and a ground conductor.

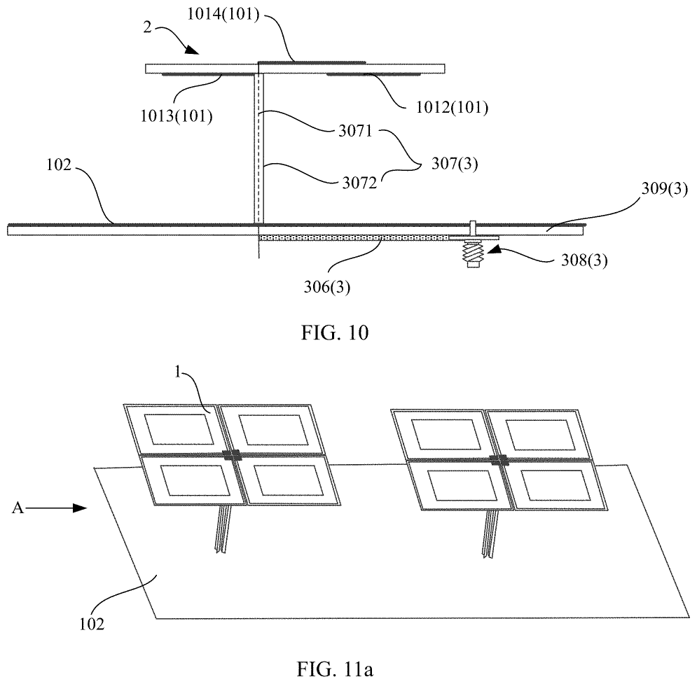

Refer to FIG. 9 and FIG. 10 together. FIG. 10 is a schematic diagram of a structure in which the radiation part 101 of the high-frequency antenna element 2 is connected to the feed structure 3 according to an embodiment of this application. In the embodiment shown in FIG. 10, the feed line 307 is a coaxial feed line, and the coaxial feed line includes an inner conductor 3071 and an outer conductor 3072 that are coaxially disposed. Usually, an insulation layer may be disposed between the inner conductor 3071 and the outer conductor 3072, to avoid a short-circuit between the inner conductor 3071 and the outer conductor 3072. The inner conductor 3071 may be used as a signal conductor of the feed line 307, and the outer conductor 3071 may be used as a ground conductor of the feed line 307. Specifically, when the radiation part 101 of the high-frequency antenna element 2 is connected to the feed structure 3, one end of the inner conductor 3071 (the signal conductor) of the feed line 307 is connected to a signal conductor of the microstrip line 306. The other end of the inner conductor 3071 is connected, through coupled feeding, to the first radiation arm 1012 by using the coupling feed structure 1014. One end of the outer conductor 3072 (the ground conductor) of the feed line 307 is connected to the strip conductor 1022, and the other end of the outer conductor 3072 is electrically connected to the second radiation arm 1013.

In embodiments shown in FIG. 9 and FIG. 10, the high-frequency antenna element 2 is a dipole antenna. In some other embodiments of this application, the high-frequency antenna element 2 may be, but is not limited to, a monopole antenna, an electromagnetic dipole antenna, a patch antenna, or the like. Regardless of a structure of the high-frequency antenna element 2, a connection manner of the high-frequency antenna element 2 is similar to that of the feed line 307. Details are not described herein again.

In addition, because the radiation part 101 of the high-frequency antenna element 2 and the microstrip line 306 are located on both sides of the reflection plate 102, to help the connection of the signal conductor of the feed line 307 to the first radiation arm 1012 and the connection of the signal conductor of the feed line 307 to the microstrip line 306 at the same time, reference is still made to FIG. 9. A through hole 10221 may be disposed on the strip conductor 1022. In this way, the feed line 307 can pass through the through hole and be connected to the microstrip line 306.

Refer to FIG. 9 and FIG. 10 together. In some embodiments of this application, the feed structure 3 may further include a feed connector 308, and the feed connector 308 and the microstrip line 306 are disposed on a same side of the reflection plate 102. The microstrip line 306 is connected to the feed connector 308. The feed connector 308 may be connected to a feed circuit, and a radio frequency signal may be transmitted to the radiation part 101 by using the feed connector 308 and the microstrip line 306 for transmission.

In some embodiments of this application, the multi-band antenna may be disposed based on a PCB structure. During specific implementation, refer to FIG. 10. Because a PCB usually includes a conductor layer and a dielectric substrate 309 disposed between two adjacent conductor layers, the reflection plate 102 and the microstrip line 306 may be disposed on two different conductor layers of the PCB. In this way, a structure and a processing technology of the multi-band antenna can be simplified.

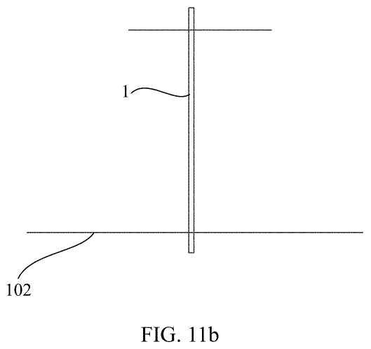

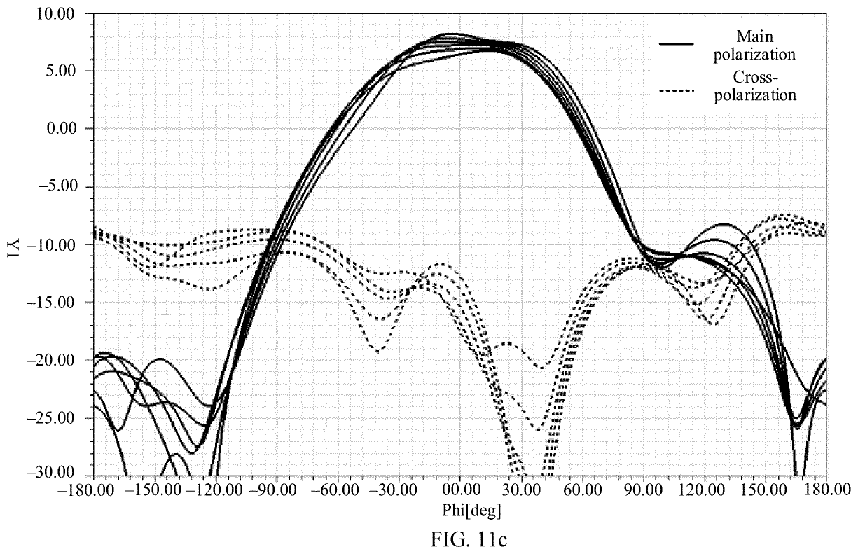

Refer to FIG. 11a and FIG. 11b. FIG. 11a shows an antenna array including two low-frequency antenna elements 1. FIG. 11b is an A-direction view of the antenna array shown in FIG. 11a. In addition, refer to FIG. 11c. FIG. 11c is a pattern simulation result of a horizontal plane of the antenna array shown in FIG. 11a. In this embodiment of this application, a working frequency of a low-frequency antenna element 1 is 0.69 GHz to 0.96 GHz.

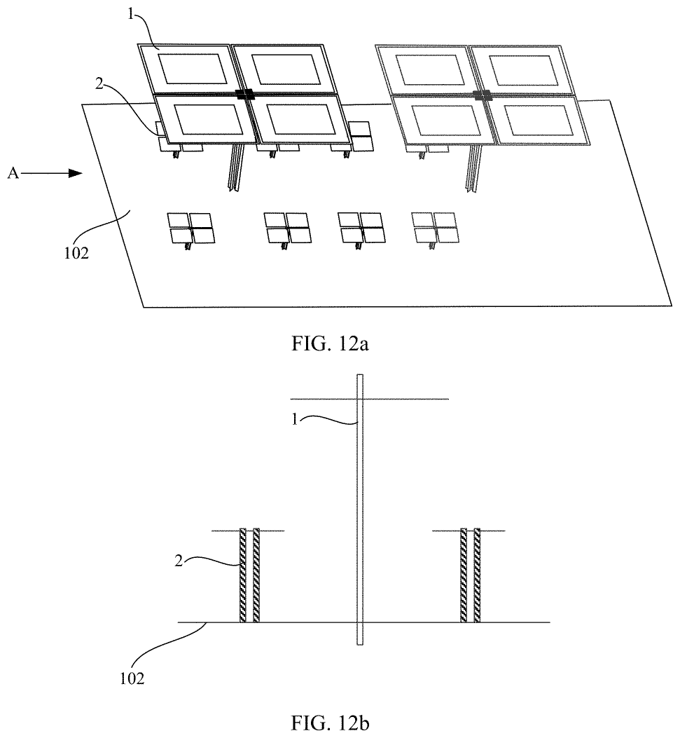

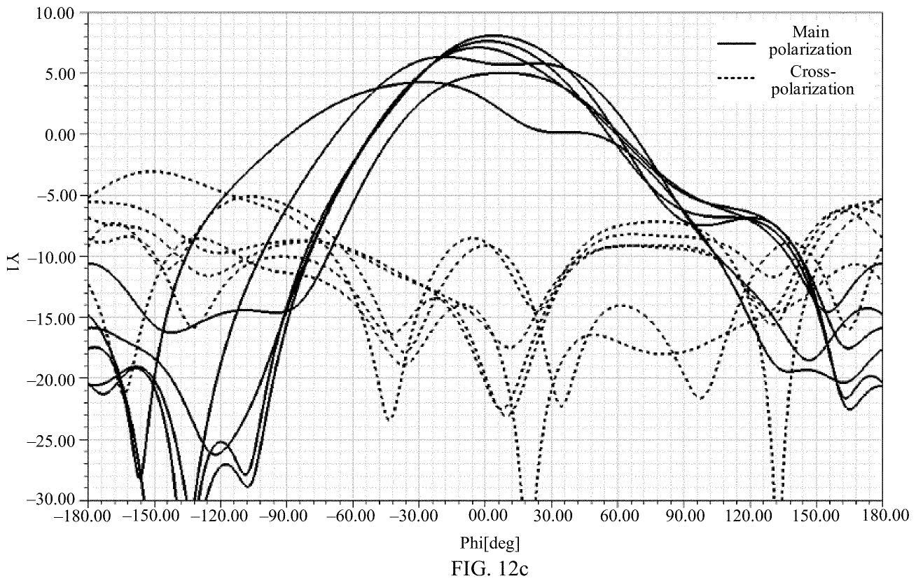

Refer to FIG. 12a and FIG. 12b. FIG. 12a shows a multi-band antenna including two low-frequency antenna elements 1 and eight high-frequency antenna elements 2. FIG. 12b is an A-direction sectional view of the multi-band antenna shown in FIG. 12a. In addition, FIG. 12c is a pattern simulation result of a horizontal plane of the multi-band antenna shown in FIG. 12a.

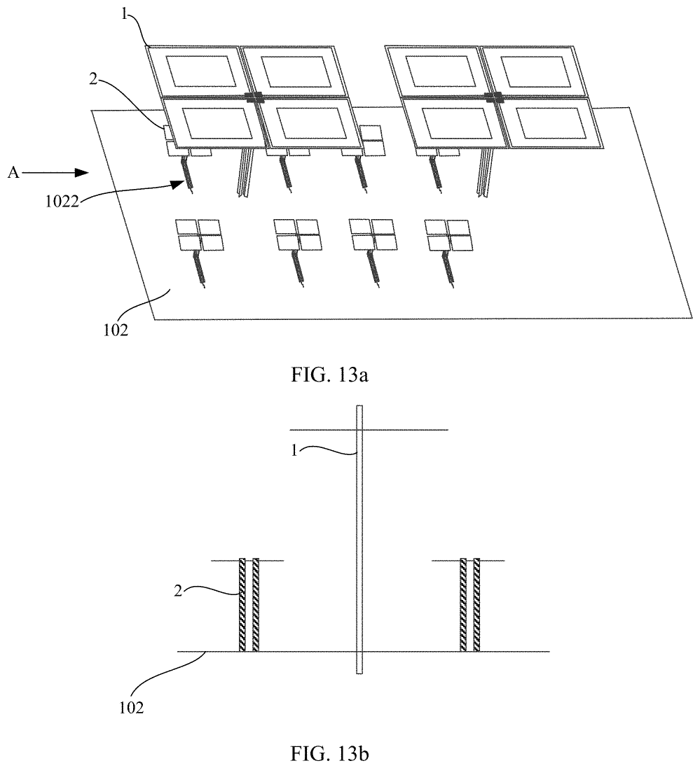

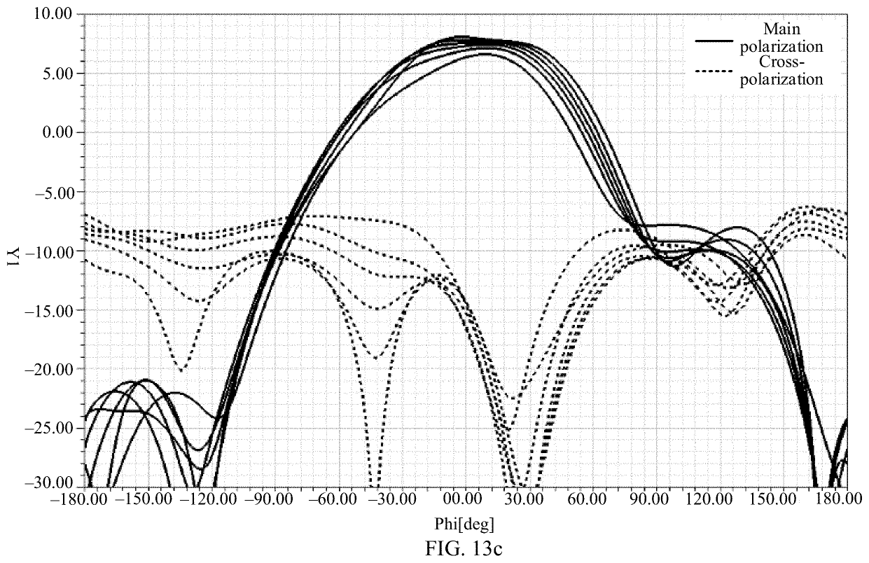

Refer to FIG. 13a and FIG. 13b. FIG. 13a shows a multi-band antenna according to an embodiment of this application. The multi-band antenna includes two low-frequency antenna elements 1 and eight high-frequency antenna elements 2. A slot is provided with a position corresponding to the high-frequency antenna elements 2 of the reflection plate 102 to form a strip conductor 1022. FIG. 13b is an A-side view of the multi-band antenna shown in FIG. 13a. In addition, FIG. 13c is a pattern simulation result of a horizontal plane of the multi-band antenna shown in FIG. 13a.

In FIG. 11c, FIG. 12c, and FIG. 13c, a vertical coordinate represents normalized gain, and a unit thereof is dB (decibel). A horizontal coordinate represents an azimuth Phi, and a unit thereof is “°” (namely, degree). A solid line part represents a main polarization pattern, and a dashed line part represents a cross-polarization pattern. Meanings of curves in FIG. 11c, FIG. 12c, and FIG. 13c are similar to those in FIG. 4a and FIG. 4b, and details are not described herein again.

By comparing FIG. 11c and FIG. 12c, it can be learned that a downward depression occurs on a top part of a main lobe of the solid line part in FIG. 12c relative to a top part of a main lobe of the solid line part in FIG. 11c. This indicates that, after the high-frequency antenna element 2 is disposed in an array of the low-frequency antenna element 1, the gain stability of the low-frequency antenna element 1 deteriorates. In addition, an average value of the dashed line part in FIG. 12c is greatly improved compared with an average value of the dashed line part in FIG. 11c. This indicates that, after the high-frequency antenna element 2 is disposed in the array of the low-frequency antenna element 1, the polarization suppression ratio of the low-frequency antenna element 1 deteriorates. In addition, by comparing FIG. 13c and FIG. 12c, it can be learned from that, via the multi-band antenna provided in this application, a pattern of a low-frequency antenna element 1 is significantly improved. In addition, a minimum gain value is increased from about 5.2 dB to about 6.8 dB.

Therefore, by using the multi-band antenna provided in this application, a common mode suppression inductor structure formed by the strip conductor 1022 can effectively suppress a common mode induced current generated on the high-frequency antenna element 2. In this way, directivity parameters such as a polarization suppression ratio and gain stability of the low-frequency antenna element 1 are significantly improved. In addition, because the strip conductor 1022 is formed by slotting the reflection plate 102, to be specific, the strip conductor 1022 is used as a part of the reflection plate 102, a processing technology of the strip conductor is simple, and an additional structure and an assembly process do not need to be added. Therefore, the manufacturing costs of the multi-band antenna are low.

In addition to significantly improving directivity parameters such as a polarization suppression ratio and gain stability of the low-frequency antenna element 1, impact of directivity parameters such as a front-to-back ratio, a polarization suppression ratio, and gain stability of the high-frequency antenna element 2 can be further reduced in this application, to improve radiation performance of the multi-band antenna.

In a possible embodiment of this application, it may be considered that a length of the slot 1021 in the cabling direction of the strip conductor 1022 is controlled, but at the same time, the length of the strip conductor 1022 cannot be shortened. This avoids reducing an equivalent inductance of the common mode suppression inductor structure formed by the strip conductor 1022, so that a common mode induced current generated on the high-frequency antenna element 2 can be effectively suppressed.

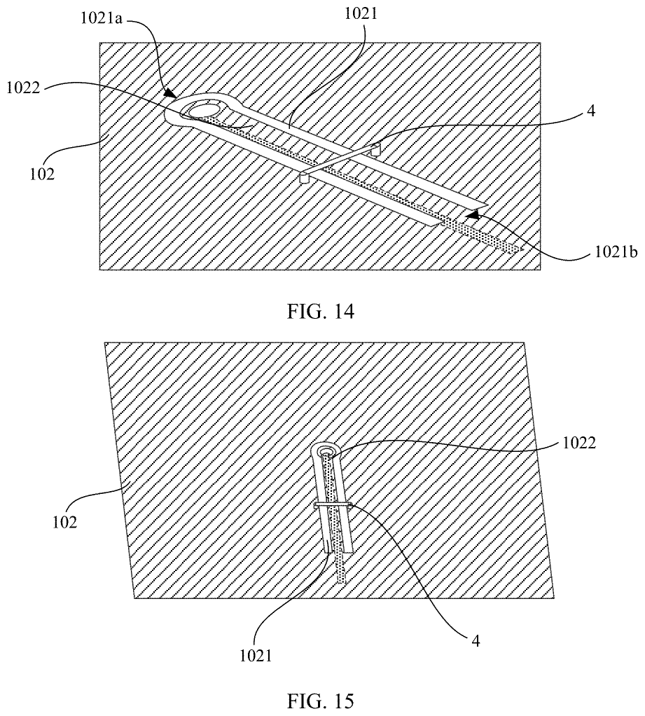

FIG. 14 is a schematic diagram of a structure of a reflection plate of a multi-band antenna according to an embodiment of this application. In this embodiment, a slot 1021 is a continuous slot continuously disposed on the reflection plate 102, and a shape formed by the slot 1021 has a bottom 1021a and an open end 1021b. The multi-band antenna may further include a first jumper member 4, so that a length of the slot 1021 in a cabling direction of the strip conductor 1022 is adjusted via the first jumper member 4.

During specific implementation, the strip conductor 1022 may be located between the first jumper member 4 and the microstrip line 306, two ends of the first jumper member 4 are respectively located on two sides that are of the slot 1021 and that are away from the strip conductor 1022, and the two ends of the first jumper member 4 are separately connected to the reflection plate 102. Further, the first jumper member 4 is disposed between the bottom 1021a of the slot 1021 and the open end 1021b, and a projection of the first jumper member 4 on the reflection plate 102 divides the slot 1021 into two parts. In this way, the slot 1021 forms a short-circuit structure at a position of the first jumper member 4, which is equivalent to shortening a size of the slot 1021 in the cabling direction of the strip conductor 1022. Therefore, leakage of a high-frequency signal from the slot 1021 to the back of the reflection plate 102 can be effectively reduced and impact of directivity parameters such as a front-to-back ratio, a polarization suppression ratio, and gain stability of the high-frequency antenna element 2 can be reduced. In some other embodiments of this application, the microstrip line 306 may be further located between the first jumper member 4 and the strip conductor 1022. A specific disposing manner of the microstrip line 306 is similar to that in the foregoing embodiment, and details are not described herein again.

It may be understood that, in this embodiment of this application, the first jumper member 4 is disposed on the reflection plate 102, and the first jumper member 4 does not affect a specific disposition of the strip conductor 1022. An equivalent inductance of the common mode suppression inductor structure formed by the strip conductor 1022 does not change. Therefore, the common mode induced current generated on the high-frequency antenna element 2 can be effectively suppressed. In this way, directivity parameters such as a polarization suppression ratio and gain stability of the low-frequency antenna element 1 are significantly improved.

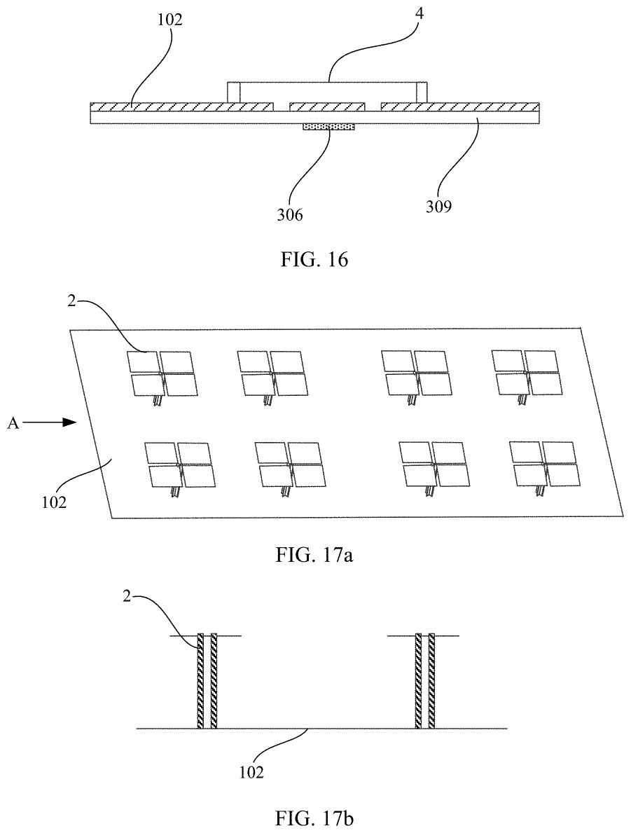

FIG. 15 is a schematic diagram of a structure of a reflection plate in a multi-band antenna according to a possible embodiment of this application. In this embodiment of this application, the slot 1021 may be, but is not limited to, a U-shaped slot. Further, at least a part of a projection of the microstrip line 306 on the reflection plate 102 may fall within the region defined by the U-shaped groove. For example, still refer to FIG. 15. A cabling direction of the microstrip line 306 is the same as that of the strip conductor 1022. In a direction perpendicular to cabling of the strip conductor 1022, a width of a projection of the microstrip line 306 on the reflection plate 102 may be less than or equal to a width of the strip conductor 1022. In the cabling direction of the strip conductor 1022, a length of a projection of the microstrip line 306 on the reflection plate 102 is greater than a length of the strip conductor 1022. In this way, a part of the projection of the microstrip line 306 on the reflection plate 102 is located on an area defined by the U-shaped slot, and the other part extends from an opening of the U-shaped slot to the defined area. This may be understood as that the projection of the microstrip line 306 on the reflection plate 102 is inserted in the area defined by the U-shaped slot. This ensures impedances of all parts of the microstrip line 306 are continuous. This can improve radiation efficiency and working stability of the high-frequency antenna element 2.

In some embodiments of this application, the multi-band antenna may be disposed based on a PCB structure. During specific implementation, reference may be made to FIG. 16. Because a PCB usually includes a conductor layer and a dielectric substrate 309 disposed between two adjacent conductor layers, the first jumper member 4, the reflection plate 102, and the microstrip line 306 may be separately disposed on different conductor layers of a printed circuit board. In this embodiment, two ends of the first jumper member 4 may be separately connected to the reflection plate 102 through a via provided on the printed circuit board. Therefore, a structure and a processing technology of the multi-band antenna can be effectively simplified.

It may be understood that other structures of the multi-band antenna in this embodiment of this application may be disposed with reference to the foregoing embodiment, and details are not described herein again.

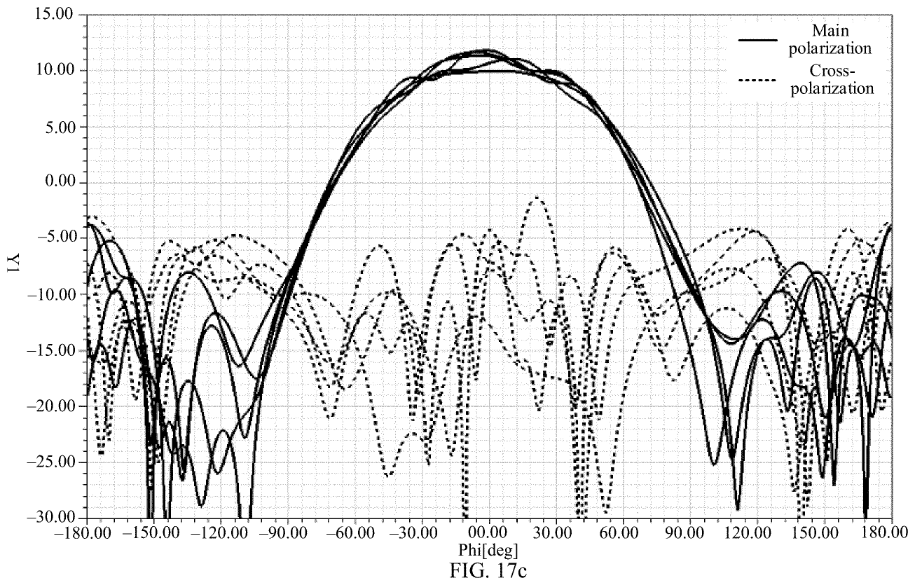

Refer to FIG. 17a and FIG. 17b. FIG. 17a shows an antenna array including eight high-frequency antenna elements 2. FIG. 17b is an A-direction view of the antenna array shown in FIG. 17a. In addition, refer to FIG. 17c. FIG. 17c is a pattern simulation result of a horizontal plane of the high-frequency antenna element 2 in the antenna array shown in FIG. 17a. In this embodiment of this application, a working frequency of the high-frequency antenna element 2 is 1.90 GHz to 2.10 GHz.

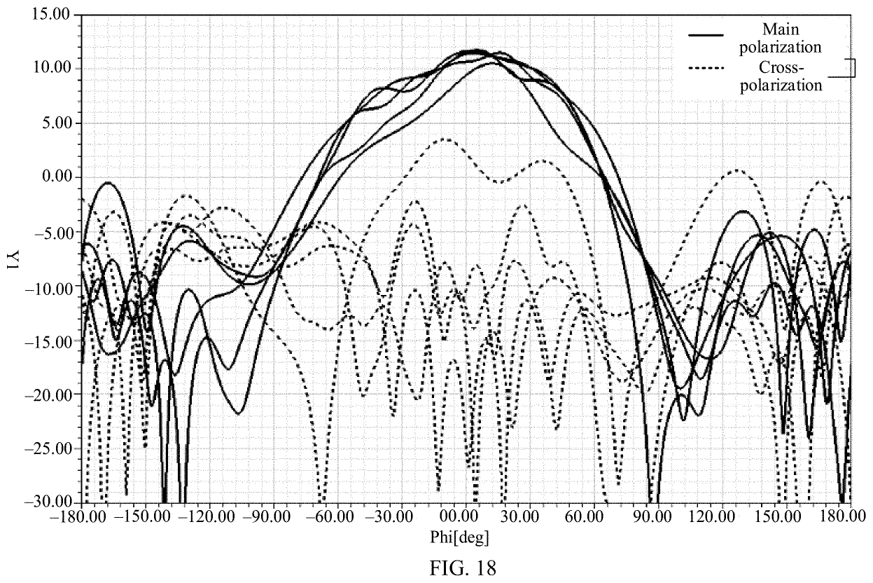

FIG. 18 is a pattern simulation result of a horizontal plane of the high-frequency antenna element 2 in the multi-band antenna shown in FIG. 13a.

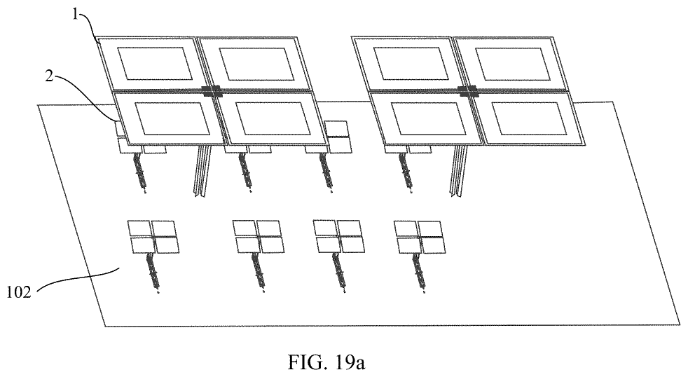

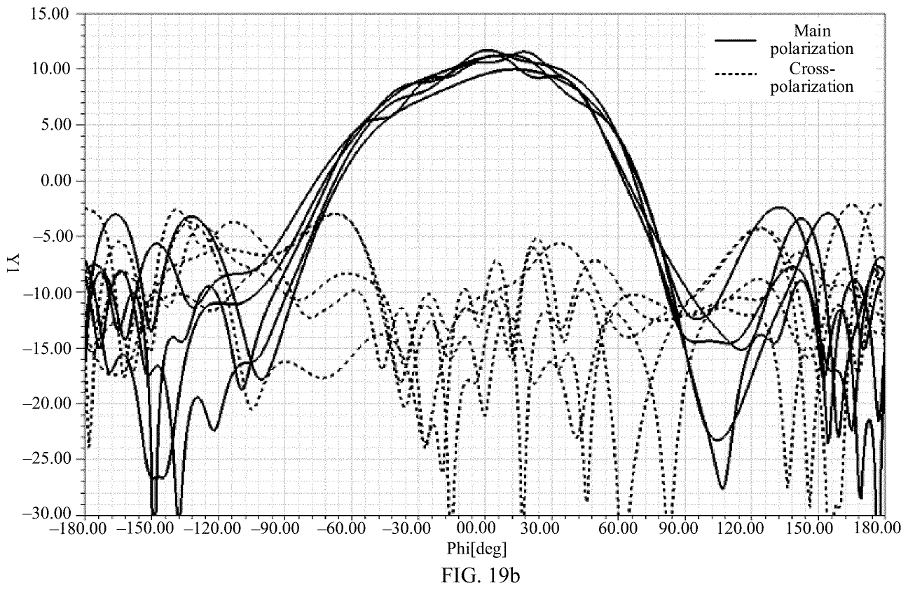

Refer to FIG. 19a and FIG. 19b. FIG. 19a shows a multi-band antenna according to an embodiment of this application. The multi-band antenna includes two low-frequency antenna elements 1 and eight high-frequency antenna elements 2. A slot is provided with a position corresponding to the high-frequency antenna element 2 of the reflection plate 102, and a first jumper member is provided between a bottom of the slot and an open end. FIG. 19b is a pattern simulation result of a horizontal plane of the high-frequency antenna element 2 in the multi-band antenna shown in FIG. 19a.

In FIG. 17c, FIG. 18, and FIG. 19b, a vertical coordinate represents normalized gain, and a unit thereof is dB (decibel). A horizontal coordinate represents an azimuth Phi, and a unit thereof is “°” (namely, degree). A solid line part represents a main polarization pattern, and a dashed line part represents a cross-polarization pattern. Meanings of curves in FIG. 17c, FIG. 18, and FIG. 19b are similar to those in FIG. 4a and FIG. 4b, and details are not described herein again.

By comparing FIG. 17c and FIG. 18, it can be learned that a downward depression occurs on a top part of a main lobe of the solid line part in FIG. 18 relative to a top part of a main lobe of the solid line part in FIG. 17c. This indicates that, after the low-frequency antenna element 1 is disposed in an array of the high-frequency antenna element 2, the gain stability of the high-frequency antenna element 2 needs to be further improved. In addition, an average value of the dashed line part in FIG. 18 is greatly improved compared with an average value of the dashed line part in FIG. 17c. This indicates that, after the low-frequency antenna element 1 is disposed in the array of the high-frequency antenna element 2. Even if the strip conductor 1022 is provided with the position corresponding to the high-frequency antenna element 2 of the reflection plate 102, the polarization suppression ratio of the high-frequency antenna element 2 deteriorates. In addition, by comparing FIG. 19b and FIG. 18, it can be learned that, via the multi-band antenna provided in this application, a pattern distortion of a high-frequency antenna element 2 is significantly improved. A width of a 3 dB beam ranges from 41.8° to 77.2° and is improved to 66.7°-79°. At the same time, an axial cross suppression ratio is improved by about 11.6 dB.

Therefore, by using the multi-band antenna provided in this embodiment of this application, because the first jumper member 4 is disposed between the bottom 1021a and the open end 1021b of the slot 1021, and a projection of the first jumper member 4 on the reflection plate 102 divides the slot 1021 into two parts. In this way, the slot 1021 forms a short-circuit structure at a position of the first jumper member 4, which is equivalent to shortening a size of the slot 1021 in the cabling direction of the strip conductor 1022. Therefore, impact of directivity parameters such as a front-to-back ratio, a polarization suppression ratio, and gain stability of the high-frequency antenna element 2 can be effectively reduced. In addition, the first jumper member 4 is disposed on the reflection plate 102, and the first jumper member 4 does not affect a specific disposition of the strip conductor 1022. An equivalent inductance of the common mode suppression inductor structure formed by the strip conductor 1022 does not change. In this way, the common mode induced current generated on the high-frequency antenna element 2 can be effectively suppressed, and directivity parameters such as a polarization suppression ratio and gain stability of the low-frequency antenna element 1 are significantly improved.

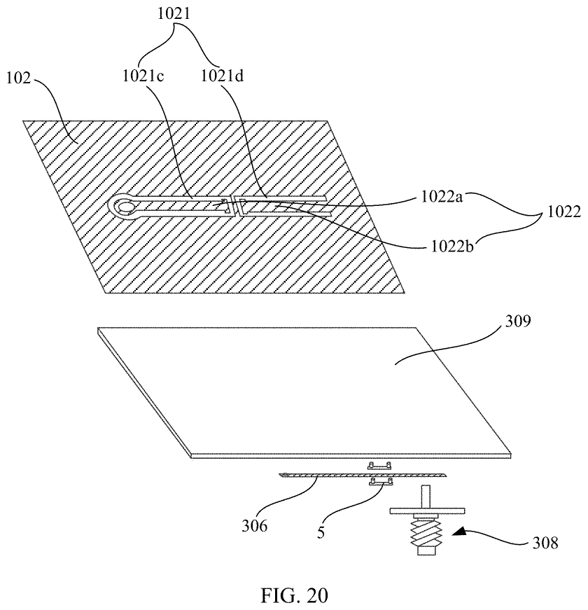

In this application, the length of the slot 1021 in the cabling direction of the strip conductor 1022 may be controlled in another manner than the foregoing manner of disposing the first jumper member 4 on the reflection plate 102. For example, FIG. 20 is a schematic diagram of a structure of a multi-band antenna according to a possible embodiment of this application. In this embodiment, the slot 1021 includes a first slot part 1021c and a second slot part 1021d that are separated from each other, and the strip conductor 1022 includes a first conductor part 1022a and a second conductor part 1022b that are connected to each other. During specific implementation, the slot 1021 defines the strip conductor 1022, the first conductor part 1022a may be defined by the first slot part 1021c, and the second conductor part 1022b may be defined by the second slot part 1021d.

When the slot 1021 is specifically disposed, reference is still made to FIG. 20. The first slot part 1021c may be a closed ring-shaped slot, and a shape of the ring-shaped slot may be, but is not limited to, an “O” shape, a “D” shape, or the like. The second slot part 1021d may be a semi-enclosed semi-closed slot having an opening at one end, and a shape of the semi-closed slot may be, but is not limited to, a U shape. When the second slot part 1021b is a U-shaped slot, the opening of the U-shaped slot faces a side that is away from the first slot part 1021c. In this way, the layer on which the reflection plate 102 is located, the first conductor part 1022a and the second conductor part 1022b of the strip conductor 1022 are two sections that are not connected to each other, and the second conductor part 1022b is grounded.

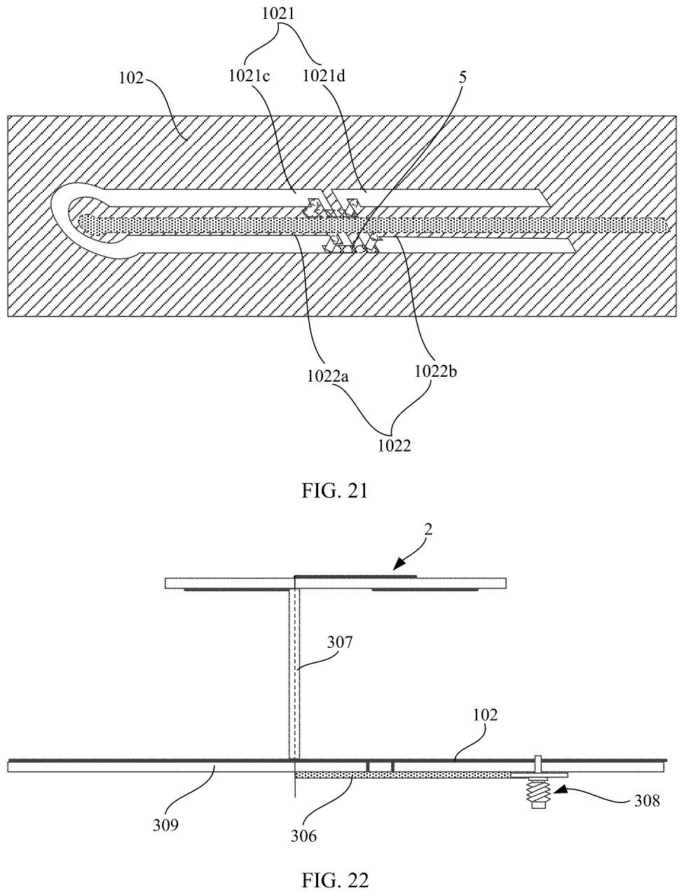

In this application, the first conductor part 1022a and the second conductor part 1022b of the strip conductor 1022 are connected in many manners. FIG. 21 is a schematic diagram of a structure of a reflection plate in a multi-band antenna according to another possible embodiment of this application. In this embodiment, the multi-band antenna includes a second jumper member 5, and two ends of the second jumper member 5 are respectively connected to the first conductor part 1022a and the second conductor part 1022b. Thus, the first conductor part 1022a and the second conductor part 1022b are connected by using the second jumper member 5.

It may be understood that, in this embodiment of this application, a part of the reflection plate 102 located on circumferential side of the slot connects through a short circuit between the first slot part 1021c and the second slot part 1021d by the second jumper member 5, which is equivalent to shortening a size of the slot 1021 in the cabling direction of the strip conductor 1022. Therefore, leakage of a high-frequency signal from the slot 1021 to a back of the reflection plate 102 can be effectively reduced, and impact of directivity parameters such as a front-to-back ratio, a polarization suppression ratio, and gain stability of the high-frequency antenna element can be reduced.

Further, when the first conductor part 1022a and the second conductor part 1022b are connected by the second jumper member 5, the length of the cabling direction of the strip conductor 1022 is substantially not affected. The equivalent inductance of the common mode suppression inductor structure formed by the strip conductor 1022 does not change. Therefore, the common mode induced current generated on the high-frequency antenna element 2 can be effectively suppressed. In this way, directivity parameters such as a polarization suppression ratio and gain stability of the low-frequency antenna element 1 are significantly improved.

Refer to FIG. 22. In this embodiment of this application, the multi-band antenna may be disposed based on a PCB structure. Because a PCB is usually composed of a conductor layer and a dielectric substrate 309 disposed between two adjacent conductor layers, the reflection plate 102 and the microstrip line 306 may be disposed at different conductor layers of the printed circuit board. The second jumper member (not shown) and the microstrip line 306 are disposed on the same conductor layer of the printed circuit board. By using the multi-band antenna in this solution, it can avoid increasing a quantity of the conductor layer of the PCB. Therefore, costs of the multi-band antenna are effectively reduced. In addition, in this embodiment, the two ends of the second jumper member 5 may be respectively connected to the first conductor part 1022a and the second conductor part 1022b through a via provided on the printed circuit board. Therefore, a structure and a processing technology of the multi-band antenna can be effectively simplified.

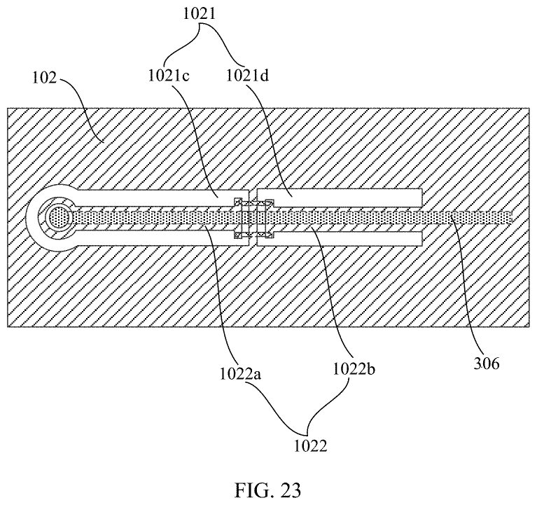

In this embodiment of this application, a quantity of second jumper member 5 is not specifically limited. For example, refer to FIG. 21 and FIG. 23. There may be two second jumpers member 5, and the two second jumper members 5 are respectively located on two sides of the microstrip line 306. Two ends of the two second jumper members 5 are respectively connected to the first conductor part 1022a and connected to the second conductor part 1022b. Refer to FIG. 22. By using this solution, a return current of the microstrip line 306 is continuous, which effectively improves impedance continuity of all parts of the microstrip line 306, and further improves radiation efficiency and working stability of the high-frequency antenna element 2.

In addition, in this embodiment of this application, to control the impedance of the microstrip line 306, a spacing between the microstrip line 306 and the second jumper member 5 may be adjusted. For example, the spacing between the second jumper member 5 and the microstrip line 306 is 0.1 to 10 times the thickness of the dielectric substrate 309, to implement impedance continuity of all parts of the microstrip line 306.

It may be understood that other structures of the multi-band antenna in this embodiment of this application may be disposed with reference to the foregoing embodiment, and details are not described herein again.

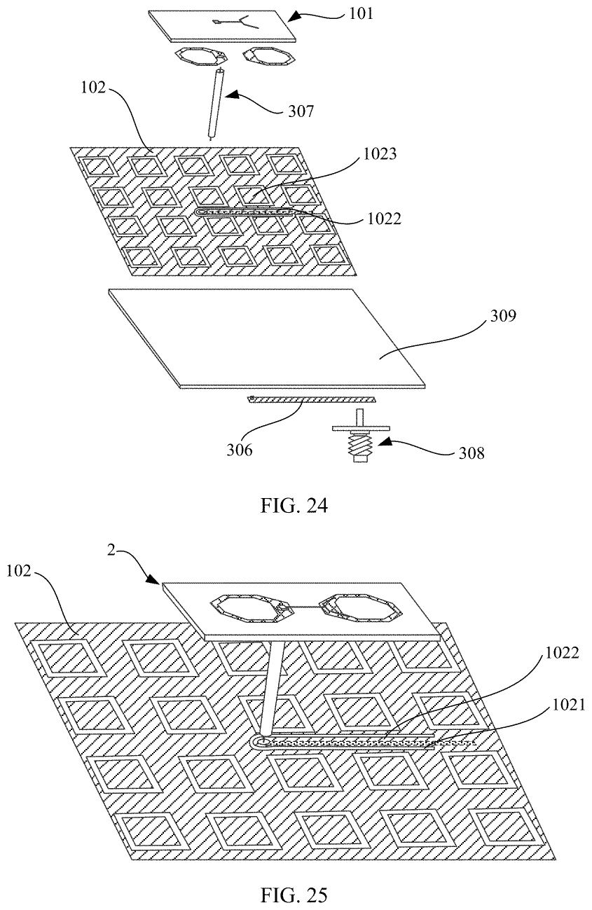

Considering that a frequency selective surface (FFS) has functions of directional reflection, spatial filtering, feed, and common mode suppression, to enable a multi-band antenna to integrate more functions. In some embodiments of this application, refer to FIG. 24 and FIG. 25. The reflection plate 102 may also have a periodically arranged grid structure 1023. In this embodiment, the strip conductor 1022 may be disposed on a locally continuous metal plane between the grid structures 1023. Alternatively, the strip conductor 1022 may be further disposed in an interval of a single grid structure 1023, to implement comprehensive performance optimization of the multi-band antenna. In addition, in this embodiment, other structures of the multi-band antenna may be disposed with reference to any one of the foregoing embodiments, and details are not described herein again.

This application further provides a communication device. The communication device includes the multi-band antenna in any one of the foregoing embodiments. The communication device may be, but is not limited to, a base station, a radar, or another device. In the communication device, a common mode suppression inductor structure formed by a strip conductor can effectively suppress a common mode induced current generated on a high-frequency antenna element. In this way, directivity parameters such as a polarization suppression ratio and gain stability of the low-frequency antenna element 1 are significantly improved. In addition, impedances of all parts of the microstrip line are continuous. This can improve radiation efficiency and working stability of the high-frequency antenna element. In addition, manufacture costs of the multi-band antenna are low. In this way, costs of an entire communication device can be effectively reduced.

It is clearly that a person skilled in the art can make various modifications and variations to this application without departing from the scope of this application. In this way, if these modifications and variations to this application fall within the scope of the claims of this application and their equivalent technologies, this application is also intended to cover these modifications and variations.

What is claimed is:

1. A multi-band antenna, comprising a reflection plate and a feed structure, wherein:
the reflection plate is provided with a slot, the slot defines a strip conductor, the strip conductor is a part of the reflection plate, and one end of the strip conductor is connected to another part of the reflection plate; and
the feed structure comprises a microstrip line used in a high-frequency antenna element in the multi-band antenna, wherein the microstrip line is located on one side of the reflection plate, and at least a part of a projection of the microstrip line on the reflection plate falls within a contour range of the strip conductor.

2. The multi-band antenna according to claim 1, wherein the feed structure further comprises a feed line, the feed line is configured to feed power to a radiation part of the high-frequency antenna element, a signal conductor of the feed line is connected to the microstrip line, and a ground conductor of the feed line is connected to the strip conductor.

3. The multi-band antenna according to claim 2, wherein the strip conductor has a through hole, and the signal conductor of the feed line passes through the through hole and is connected to the microstrip line.

4. The multi-band antenna according to claim 1, wherein:
the slot is a continuous slot, the multi-band antenna further comprises a first jumper member, a shape formed by the slot has a bottom and an open end, and the first jumper member is disposed between the bottom and the open end; and
the strip conductor is located between the first jumper member and the microstrip line, or the microstrip line is located between the first jumper member and the strip conductor, two ends of the first jumper member are respectively located on two sides that are of the slot and that are away from the strip conductor, and two ends of the first jumper member are separately connected to the reflection plate.

5. The multi-band antenna according to claim 4, wherein the slot is a first U-shaped slot, and the projection of the microstrip line on the reflection plate is inserted into an area defined by the first U-shaped slot.

6. The multi-band antenna according to claim 4, wherein:
the first jumper member, the reflection plate, and the microstrip line are separately located on different conductor layers of a printed circuit board; and
the first jumper member is connected to the reflection plate through a via provided on the printed circuit board.

7. The multi-band antenna according to claim 1, wherein:
the slot comprises a first slot part and a second slot part that are separated from each other, and the strip conductor comprises a first conductor part and a second conductor part that are connected to each other; and
that the slot defines a strip conductor comprises: the first slot part defines the first conductor part, and the second slot part defines the second conductor part.

8. The multi-band antenna according to claim 7, wherein the first slot part is a ring-shaped slot, the second slot part is a second U-shaped slot, and an opening of the second U-shaped slot faces a side that is away from the ring-shaped slot.

9. The multi-band antenna according to claim 7, wherein the multi-band antenna further comprises a second jumper member, and two ends of the second jumper member are respectively connected to the first conductor part and the second conductor part.

10. The multi-band antenna according to claim 9, wherein:
the reflection plate and the microstrip line are located on different conductor layers of a printed circuit board, and the second jumper member and the microstrip line are located on a same conductor layer of the printed circuit board; and
that two ends of the second jumper member are respectively connected to the first conductor part and the second conductor part comprises: the two ends of the second jumper member are respectively connected to the first conductor part and the second conductor part through a via provided on the printed circuit board.

11. The multi-band antenna according to claim 10, wherein two second jumper members are separately disposed on two sides of the microstrip line.

12. The multi-band antenna according to claim 10, wherein the printed circuit board comprises a dielectric substrate disposed between the reflection plate and the microstrip line, and a spacing between the second jumper member and the microstrip line is a first value multiplying a thickness of the dielectric substrate, wherein the first value is in a range from 0.1 to 10.

13. The multi-band antenna according to claim 1, wherein:
the feed structure further comprises a feed connector, wherein the feed connector and the microstrip line are disposed on a same side of the reflection plate; and
the microstrip line is connected to the feed connector.

14. The multi-band antenna according to claim 1, wherein:
the reflection plate has periodically arranged grid structures, wherein the strip conductor is disposed between the periodically arranged grid structures; or
the strip conductor is disposed in the periodically arranged grid structures.

15. The multi-band antenna according to claim 1, wherein in a direction perpendicular to cabling of the strip conductor, a width of the strip conductor is a second value multiplying a width of the microstrip line, wherein the second value is in a range from 0.2 to 5.

16. The multi-band antenna according to claim 15, wherein in the direction perpendicular to the cabling of the strip conductor, the width of the strip conductor is in a range from 0.1 mm to 10 mm.

17. The multi-band antenna according to claim 1, wherein in a cabling direction of the strip conductor, a length of the strip conductor is greater than one-twentieth of a wavelength of a low-frequency antenna element.

18. The multi-band antenna according to claim 1, wherein a ratio of a length of the strip conductor in a cabling direction to a width of the strip conductor in a direction perpendicular to the cabling direction of the strip conductor is greater than 5:1.

19. The multi-band antenna according to claim 1, wherein a maximum spacing between a low-frequency antenna element and a high-frequency antenna element of the multi-band antenna is less than 0.5 multiplying a wavelength of the low-frequency antenna element.

20. A communication device, comprising a multi-band antenna, wherein the multi-band antenna comprises a reflection plate and a feed structure, and wherein:
the reflection plate is provided with a slot, the slot defines a strip conductor, the strip conductor is a part of the reflection plate, and one end of the strip conductor is connected to another part of the reflection plate; and
the feed structure comprises a microstrip line used in a high-frequency antenna element in the multi-band antenna, wherein the microstrip line is located on one side of the reflection plate, and at least a part of a projection of the microstrip line on the reflection plate falls within a contour range of the strip conductor.
